(19) United States
(12) Patent Application Publication
(10) Pub. No.: US 2012/0024903 A1
(43) Pub. Date: Feb. 2, 2012

(54) Multiple beverage dispenser with spigot

(76) Inventors: James Mitchell Leith, SR., Moody, AL (US); Trace Malone Leith, Hoover, AL (US)

(21) Appl. No.: 12/931,274

(22) Filed: Jan. 28, 2011

Related U.S. Application Data
(63) Continuation of application No. 12/927,027, filed on Nov. 5, 2010.
(60) Provisional application No. 61/456,523, filed on Nov. 9, 2010.
(60) Provisional application No. 61/400,372, filed on Jul. 28, 2010.

(51) Int. Cl. B67D 7/06; B65D 35/38

(52) U.S. Cl. 222/185.1; 222/568

(57) ABSTRACT

A multiple option beverage dispenser, having a spigot, for gravitationally dispensing a liquid beverage from standard recyclable plastic bottle containers, having standard screwed necks, available commercially. The instant invention called “Multiple Beverage Dispenser with Spigot” is a two piece device, preferably injection molded of preferred plastic construction, for economy of production. The heart of the instant inventions' design comprises a multi-tiered female threaded bottle receiver, a fluid chamber, and a tubular discharge end having a standard male threaded coupling and seal, and a manually operated spigot having a standard female threaded coupling for assembly to said male threaded coupling. The instant invention is designed as companion equipment when installed into a wide variety of commercially produced host ice cooler/chests having dispensing spigots, or that spigots may be added (retro-fitted), providing a unique scope of utility, size, durability, and appearance.

### BACKGROUND OF THE INVENTION

1. Field of Invention

The technical field of invention relates to devices for the dispensing of bottled drinking beverages (liquids) having a receiving device to deplete liquid gravitationally from standard sized bottled drinking water. This instant invention comes within the field of manually dispensing a beverage from a commercially produce standard bottle container, with screwed neck, from within a commercially produced host thermal ice cooler/chest of a single beverage, having a dispensing spigot. More specifically, it relates to the ability of the instant invention, as a companion device installed within a spigot ice cooler/chest, or where a spigot may be added (retro-fitted), whereby a wide variety of beverages may be employed to dispense via the existing or add-on spigot.

2. Description of Prior Art

Among Outdoor & Sports Product users, Contractors, Industrial work crews, and other users of thermal ice cooler/chests having spigots, it is a universally accepted practice to introduce a single beverage (i.e. water and/or ice) into the cooler/chest and manually dispense the chilled media via the existing spigot into a hand held receiver (i.e. drink cup). In recent times, there have been patents issued for “Portable Bottled Water Dispenser” being a totally self-contained, stand alone process for extracting & disbursement of bottled water, which sets them apart from dispensing through a host ice cooler/chest. This utilization practice offers no advantage of introducing multiple choice of beverage, in addition to the (water) media inside the ice cooler/chests cavity. The improvement and usefulness of the instant invention, over the prior art, is to offer users of new and existing host ice cooler/chests the instant capability of providing a wide range of commercially available beverages of differing threaded neck sizes, while maintaining the chilled water media aspect.

### SUMMARY OF THE INVENTION

The instant invention was conceived to offer options to users of ice cooler/chests having spigots, or where spigots may be added, providing an endless variety of beverage choice over the single beverage utility of said ice cooler/chests. The instant invention forms a true companion device to said ice cooler/chests with or without spigots, whereby enabling choice of beverage. The instant invention, constructed of preferably non-conductive recyclable plastic, similar to that of commercially produced ice cooler/chests, and preferred injection molded in two pieces with no moving parts, for economy of manufacture. The heart of the instant invention design consists of a unique multiple tiered female threaded bottle receiver to accept an *assortment of different size standard threaded neck recyclable plastic bottles or jugs commercially produced of available popular beverages. The instant invention was perceived and designed to be installed into the interior bottom of said host ice cooler/chest at the proper relationship to the existing ice cooler/chest's spigot position for mounting thereto. After the final installation, the existing ice cooler/chest spigot may be disassembled and removed, or replaced by a new spigot, without disturbing the presents of the instant invention. *Accommodation of bottle sizes with screwed necks: (1) standard 2 liter, (2) standard ½ or 1 gallon, & (3) standard 64 ounce.

The use of the instant invention, after installation, is to simply remove bottle cap from beverage bottle, invert the cooler/chest containing the instant invention, and insert (screw) bottle into the appropriate size threaded receiver tier and secure tightly, set ice cooler/chest back upright. A small hole must be administered to the bottom end of bottle for venting. Manually activate the existing host ice cooler/chest spigot and beverage will deplete normally by natural liquid gravity until existing spigot is deactivated for quantity desired. Upon depletion of selected beverage, repeat the loading process with another beverage of choice, as many times as required. Replace coolant media as necessary.

### BRIEF DESCRIPTION OF DRAWINGS

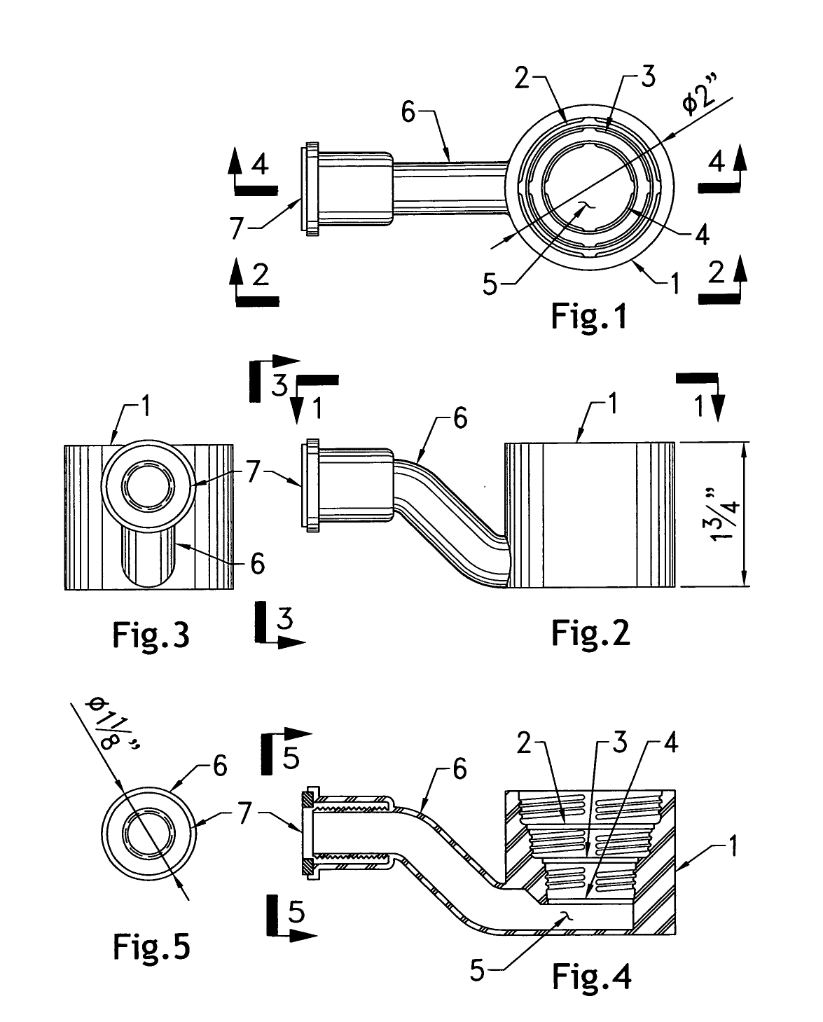

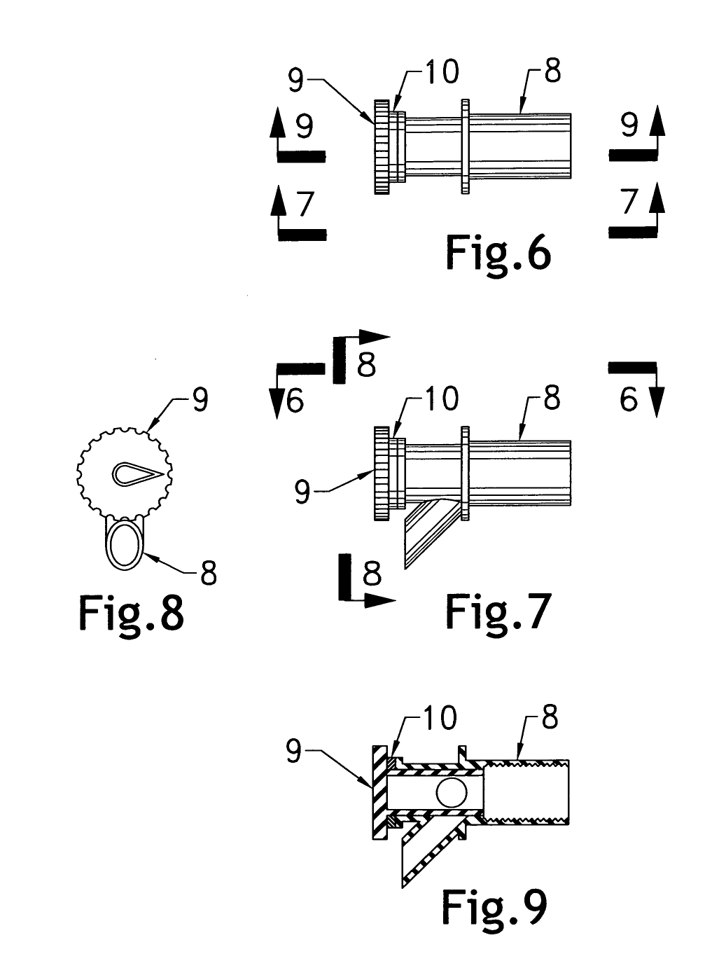

Drawing 1/2 shows three (3) basic external views. Plan FIG. 1, Side FIG. 2, and Front FIG. 3. FIG. 4 shows a longitudinal “Section” and FIG. 5 shows the discharge end. Drawing 2/2 also shows three (3) basic external views. Plan FIG. 6, Side FIG. 7, and Front FIG. 8. FIG. 9 shows a longitudinal “Section”. All objects are depicted in orthographic planes with minimal control dimensions to indicate scope (size) of instant invention. Included is a sketch for your use, to indicate intended use, for the “Front Page View”. The drawings sheet 1/2 and 2/2 are prepared per U.S. Patent specifications. Size 8 ½″×11″ as per 37 CFR 184(f) and margins as per 37 CFR 1.84(g).

### DESCRIPTION OF THE PREFERRED EMBODIMENT

In reference to the accompanying drawing sheet 1/2, the intended invention called “Multiple Beverage Dispenser with Spigot” comprises a cylindrical main body 1, as indicated in FIGS. 1, 2, 3, & 4. As shown in FIG. 1 & FIG. 4, the multiple tiers of standard female threaded bottle receivers are indicated as upper tier for 64 oz. threaded plastic containers 2, intermediate tier for ½ and 1 gallon threaded plastic containers 3, and the lower tier for 2 liter threaded plastic containers 4. Also shown, in FIGS. 1, 2, 3, 4, & 5, is the discharge tube 6, and discharge tube seal 7. The fluid channel 5 is shown in FIGS. 1 & 4. In reference to the accompanying drawing sheet 2/2, the intended invention called “Multiple Beverage Dispenser with Spigot” also comprises a companion spigot body 8, as indicated in FIGS. 6, 7, 8, & 9. Also shown in FIGS. 6, 7, 8, & 9 is the valve operator 9 and seal 10.

It is to be noted on drawing 1/2, that items numbered 1 through 6, are to be preferred monolithically and integrally molded into a single comprehensive unit of preferred plastic, similar to that of commercially produced thermal ice cooler/chests.

It is to be further noted, on drawing 2/2, that items numbered 8 and 9, are to be preferred monolithically and integrally molded into a single comprehensive unit of preferred plastic, similar to that of commercially produced thermal ice cooler/chests.

It is also further noted, that these “single comprehensive units” as in paragraphs [0007] & [0008], are designed to be installed collectively into a new or existing host ice cooler/chest, with or without an existing spigot, where one or more holes may be added for mounting the intended invention.

It is also further noted, as per drawing 1/2, that this one piece unit with item 7, as in paragraph [0007], is to be placed upright on its' base at or near the interior center of host ice cooler/chest with the discharge coupling pointed toward the spigot hole. The assembly of items 9 & 10, as per drawing 2/2, and as in paragraph [0008], are to be inserted and threaded, from the exterior through the hole, onto the discharge end coupling of the dispenser on the the interior and tighten securely. It is recommended that a water resistant glue strip similar to “Uglu” be administered between the bottom of the dispenser and the surface of the host ice cooler/chest to secure in-place.

It is also further noted, that the instant inventions spigot end may be disassembled, or removed, without disturbing the presence of the instant inventions dispenser unit resident inside said host ice cooler/chest. The dispenser will accommodate chest wall thickness of 3/16″ to 13/16″.

It is also further noted, that the instant inventions dispenser unit, may also be retrieved form said “host” ice cooler/chests and replaced by a new one.

The invention claimed is:

1. A beverage dispenser with spigot for gravitationally dispensing a liquid beverage from standard thread neck plastic bottles, the dispenser comprising:
a main body portion having internal multi-tiered standard female threaded receivers, an internal fluid channel, and a tubular discharge portion having a standard male threaded coupling, integrally formed with said body, and a separate integrally formed spigot portion having a standard female threaded coupling with an assembled manually operated flow control valve.

2. The beverage dispenser with spigot, as in claim 1, wherein said dispenser is to be made preferably of molded plastic.

3. The beverage dispenser with spigot, as in claim 2, wherein said dispenser having been installed, within a host ice cooler/chest, forms a comprehensive and unique configuration of a multiple beverage dispensing system.
